(19) United States
(12) Patent Application Publication
(10) Pub. No.: US 2011/0227919 A1
(43) Pub. Date: Sep. 22, 2011

(54) MANAGING OBJECT ATTRIBUTES IN A VIRTUAL WORLD ENVIRONMENT

(75) Inventors: Jeremy P. Bongio, Poughkeepsie, NY (US); Sean L. Dague, Poughkeepsie, NY (US); Kurt R. Taylor, Austin, TX (US)

(73) Assignee: International Business Machines Corporation, Armonk, NY (US)

(21) Appl. No.: 12/725,506

(22) Filed: Mar. 17, 2010

(51) Int. Cl. G06T 15/50; G09G 5/00

(52) U.S. Cl. 345/426; 345/581

(57) ABSTRACT

A method for managing object attributes in a virtual world environment selects a plurality of selected objects based on a supplied criterion from the user. A plurality of objects meeting the supplied criterion are visually identified to a user of the virtual world environment. The user then chooses a plurality of chosen objects from the plurality of selected objects. An object component for the chosen objects is then modified.

### BACKGROUND

The present invention relates to virtual world environments, and more specifically to managing object attributes for virtual objects within a virtual world environment.

There are several virtual world environments available to computer users. Second Life, There, and The Sims Online are three examples of such virtual world environments. Some virtual world environments allow a user to create and modify the virtual objects that are visualized in the environment. For example, the Second Life system allows a user to create new objects that are composed of one or more primitive (“prim”) elements. Each prim has a group of object attributes, such as color, texture, size, etc. These object attributes and other object components (such as associated scripts) may be modified from time to time.

### SUMMARY OF THE INVENTION

According to one embodiment of the present invention, a method for managing object attributes in a virtual world environment selects a plurality of selected objects based on a supplied criterion from the user. A plurality of objects meeting the supplied criterion are then visually identified to a user of the virtual world environment. The user then chooses a plurality of chosen objects from the plurality of selected objects. An object component for the chosen objects is then modified.

### BRIEF DESCRIPTION OF THE DRAWINGS

FIG. 1 is a block diagram of a virtual world environment as displayed to a user.

FIG. 2 illustrates an exemplary computer system that can be used to implement embodiments of the present invention.

FIG. 3 is a flowchart of exemplary steps of an algorithm/method embodiment of the invention.

FIG. 4 is a block diagram of selection dialog box that a user may use in one embodiment of the invention.

FIG. 5 is the block diagram from FIG. 1, in which some virtual objects are visually identified to the user.

FIG. 6 is a block diagram of script dialog box that a user may use to enter a script that is associated with one or more virtual objects.

FIG. 7 is a block diagram of the script dialog box from FIG. 6 after the invention has modified the script.

### DETAILED DESCRIPTION

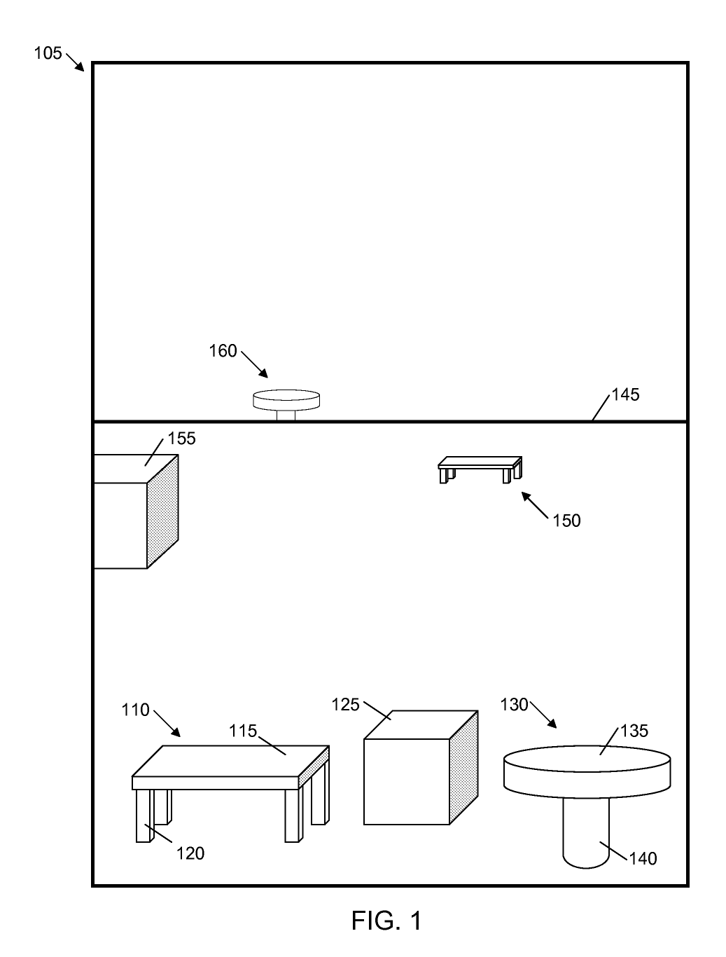

With reference now to FIG. 1, a simplified display of a virtual world environment 105 is shown. The virtual world environment 105 is displayed from the point of view of a computer user. In some virtual world environments an avatar representing the user is displayed on the computer screen with the user's viewpoint being as if looking from a few feet behind her avatar. In such a system, the user sees the back of her avatar as the user moves around and interacts with the virtual objects in the environment. In some virtual worlds, the point of view for the user is in the first person, as if the user is looking through her avatar's eyes. In Second Life, for example, this type of vantage point is referred to as Mouselook. The figures discussed here are from a first-person point of view, similar to Mouselook.

In the virtual world environment 105 of FIG. 1, various virtual objects are visualized and some are grouped together. Four box prims 120 are arranged as table legs, and along with a box prim 115 that is arranged as a table top are grouped together into a first rectangular table 110. A second rectangular table grouping 150 is shown further away towards the horizon 145.

A first circular table 130 is made up of a cylinder prim 140 used as the table leg that is positioned under another cylinder prim 135 used as the table top. A second circular table grouping 160 is positioned far way, over the horizon and is only partially visible from the user's current vantage point.

A first cube prim 125 is positioned between the rectangular table 110 and circular table 130. A second cube prim 155 is further away and is only partially visible.

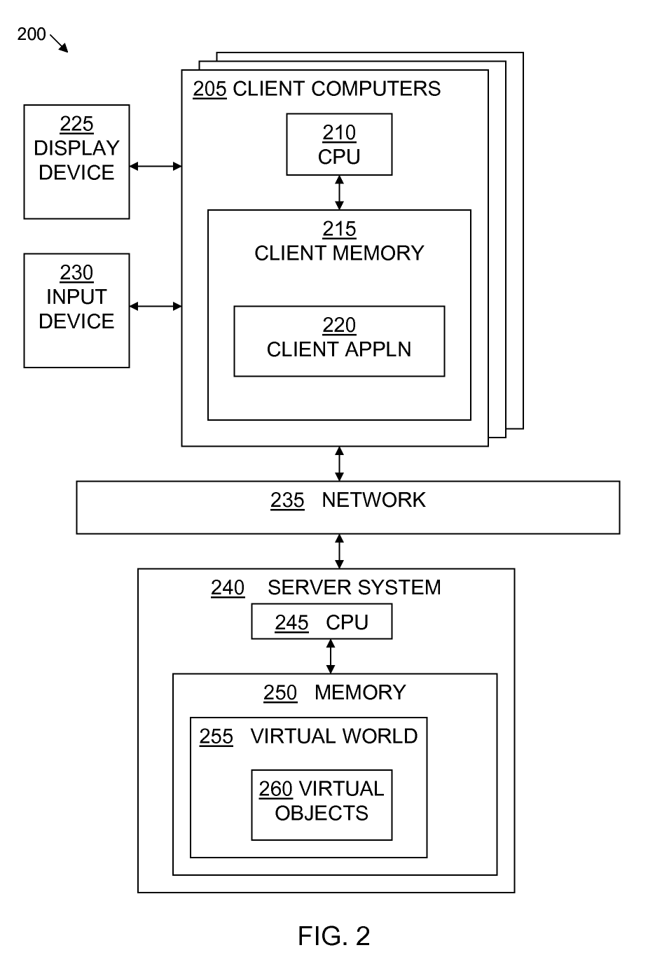

FIG. 2 is a block diagram that illustrates a client server view of computing environment 200, according to one embodiment of the invention. As shown, computing environment 200 includes client computers 205, network 235 and server system 240. In one embodiment, the computer systems illustrated in FIG. 2 are included to be representative of existing computer systems, e.g., desktop computers, server computers, laptop computers, tablet computers, and the like. The computing environment 200 illustrated in FIG. 2, however, is merely an example of one computing environment. Embodiments of the present invention may be implemented using other environments, regardless of whether the computer systems are complex multi-user computing systems, such as a cluster of individual computers connected by a high-speed network, single-user workstations, or network appliances lacking non-volatile storage. Further, the software applications illustrated in FIG. 2 and described herein may be implemented using computer software applications executing on existing computer systems, e.g., desktop computers, server computers, laptop computers, tablet computers, and the like. However, the software applications described herein are not limited to any currently existing computing environment or programming language, and may be adapted to take advantage of new computing systems as they become available.

In one embodiment, server system 240 includes a CPU 245, which obtains instructions and data via a bus from memory storage 250. The CPU 245 could be any processor adapted to support the methods of the invention. The memory 250 is any memory sufficiently large to hold the necessary programs and data structures. Memory 250 could be one or a combination of memory devices, including Random Access Memory, nonvolatile or backup memory, (e.g., programmable or Flash memories, read-only memories, etc.). In addition, memory 250 may be considered to include memory physically located elsewhere in a server 240, for example, on another computer coupled to the server 240 via a bus. Server 240 may be operably connected to the network 235, which generally represents any kind of data communications network. Accordingly, the network 235 may represent both local and wide area networks, including the Internet.

As shown, memory 250 includes virtual world 255. In one embodiment, virtual world 255 may be a software application that accepts connections from multiple clients, allowing users to explore and interact with an immersive virtual environment by controlling the actions of an avatar. Illustratively, virtual world 255 includes virtual objects 260. Virtual objects 260 represent the content present within the environment provided by virtual world 255, including both elements of the virtual world itself as well as elements controlled by a given user.

As shown in FIG. 2, each client computer 205 includes a central processing unit (CPU) 210, which obtains instructions and data via a bus from client memory storage 215. CPU 210 is a programmable logic device that performs all the instruction, logic, and mathematical processing in a computer. Client memory storage 215 stores application programs and data for use by client computer 205 and includes RAM, hard-disk drives, flash memory devices, optical media and the like. Client computer 205 is operably connected to the network 235. Client memory 215 includes an operating system (OS) and a client application 220.

In one embodiment, client application 220 provides a software program that allows a user to connect to a virtual world 105, and once connected, to explore and interact with virtual world 105. Further, client application 220 may be configured to generate and display a visual representation of the user within the immersive environment, generally referred to as an avatar. The avatar of the user is generally visible to other users in the virtual world, and the user may view avatars representing the other users. The client application 220 may also be configured to generate and display the immersive environment to the user and to transmit the user's desired actions to virtual world 105 on server 240. Such a display may include content from the virtual world determined from the user's line of sight at any given time. The user may view the virtual world 105 using a display device 225, such as an LCD or CRT monitor display, and interact with the client application 220 using input devices 230 (e.g., a keyboard and a mouse, virtual reality goggles, etc.).

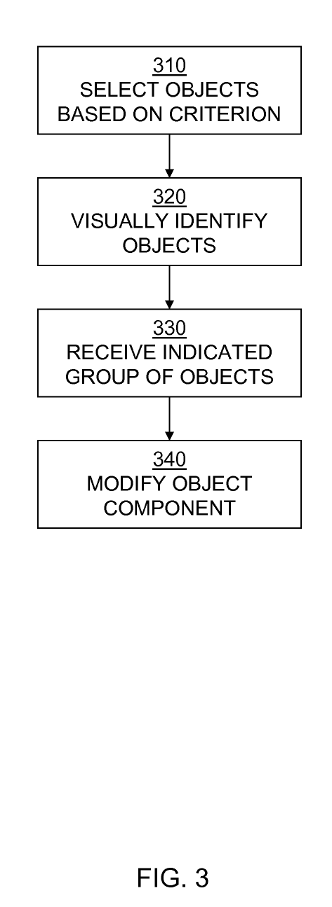

With reference now to FIG. 3, a block diagram of an embodiment of the invention is illustrated. At step 310, the invention selects a set of objects based on criteria supplied by the user. The supplied criterion may be a single value, such as a specific prim color, or it may be a range, such as a size range. The set of objects selected based on the criterion may all be the same primitive type. Or in other embodiments, prims of differing types may be selected.

At step 320, the invention visually identifies the set of objects to a user of the virtual world environment. For example, if the user selects a size range of 0.25 to 3.00 meters in step 310, then in step 320 all virtual objects in the virtual world whose size is between 0.25 and 3.00 meters are selected and visually identified to the user. The visual identification may be made in several ways. For example, a lighting attribute may be set for the group of selected objects, which causes the virtual world environment to display those objects with a lighting indication. In another embodiment, a particle system attribute for the objects may be set, which causes those objects to be displayed with a particle beam or other type of lighting source. In yet another embodiment, the objects may be selected, thus causing the objects to display with a highlight indicator surrounding the objects. One skilled in the art will recognize that there are many ways to visually identify the objects to the user.

Once the objects have been highlighted in some manner to the user, the user indicates at step 330 her choice of one, all, or a subset of the selected objects. The user may choose the objects manually by clicking on them. Or in another embodiment, the user may indicate her choice by supplying a second criterion (which may be a single criterion or multiple criteria). For example, if all virtual objects whose sizes are between 0.25 to 3.00 meters are visually identified to the user, the user may decide to choose only those such sized objects that are within 8 meters of her avatar, or she may choose only those objects whose prim type is “cylinder” and whose color is set to “brown”. One skilled in the art will recognize that there are several ways to enable the user to indicate this second criterion to choose the desired objects.

At step 340, the invention modifies an object component for the chosen set of objects. For example, the user may indicate that for all objects chosen, the prim's object attribute for color should be changed from green to blue, or that the size of all of the chosen objects should be increased by 0.4 meters, or that all occurrences of the string “CylinderSize” should be replaced with “SizeOfCylinder” in all scripts associated with the chosen objects. Step 340 takes into account that modifying an object component includes creating the object component if it does not already exist.

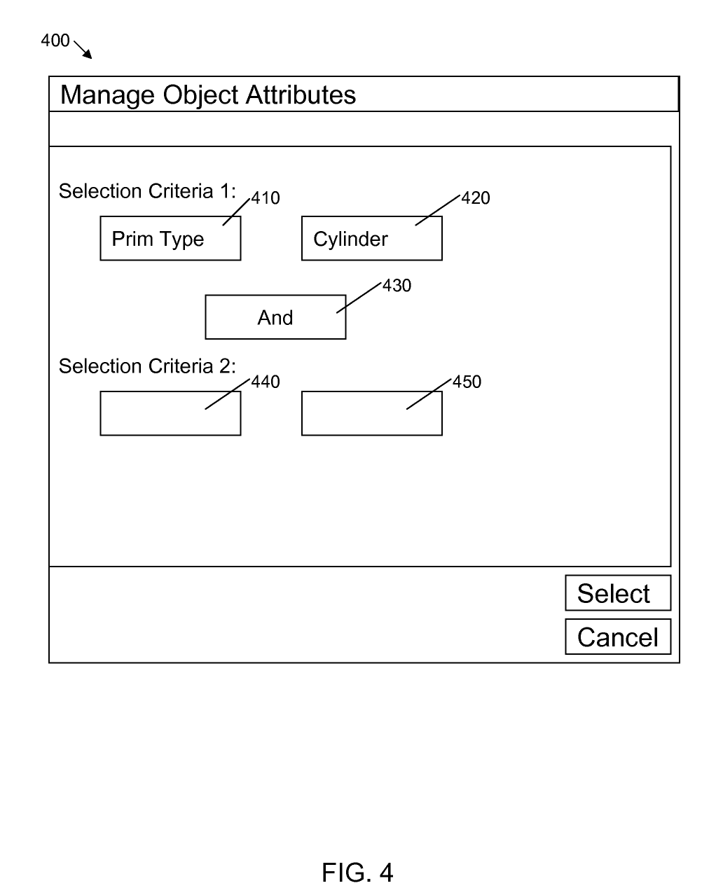

FIG. 4 shows a representative dialog box 400 that in one embodiment enables a user to supply one or more criteria indicating which objects should be highlighted by the invention. A first criteria type field 410 enables the user to choose the type of the criteria while a first criteria value field 420 enables the user to enter the value for the criteria. In the example shown in FIG. 4, the user has indicated that objects whose primitive type is cylinder should be selected by the invention. A logical connection field 430 enables a user to build a more complex statement by adding a second criteria type field 440 and a second criteria value field 450. For example, the user could use these second fields 440 and 450 to choose cylinders who height are between 1.00 and 3.00 meters, or whose color attribute is set to brown. One skilled in the art will recognize that there are numerous ways to enable a user to supply her desired criterion by which the system should select the objects.

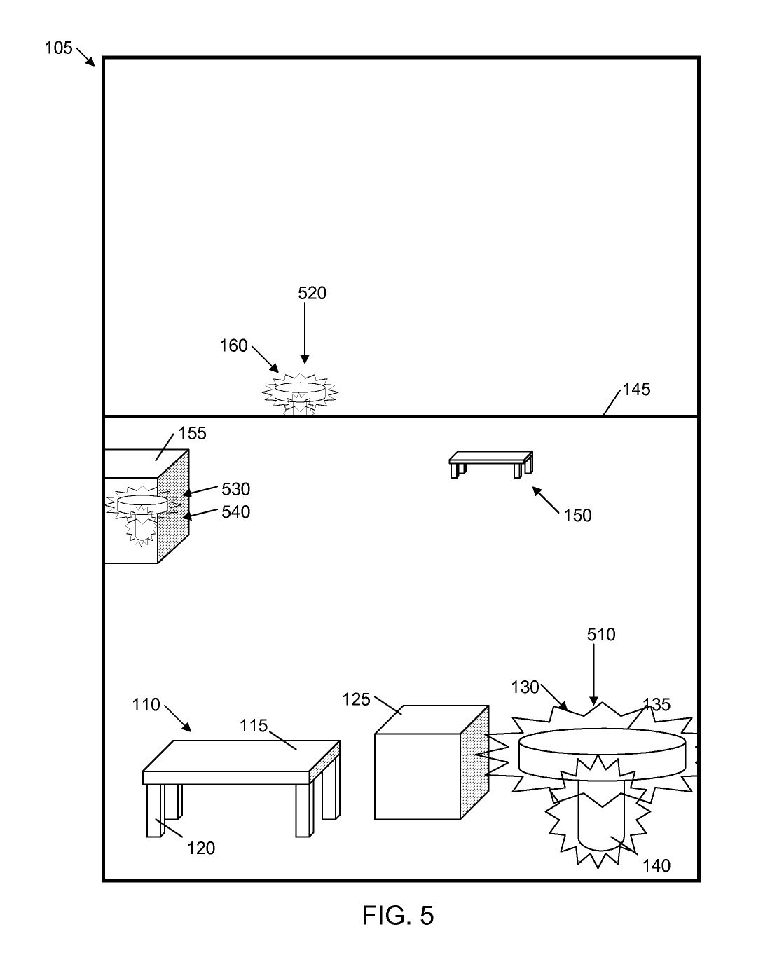

FIG. 5 illustrates one way that the invention may visually identify the selected objects to the user. Here, all prims whose prim type is cylinder are identified with light beams 510, 520, 530. Notice that in FIG. 1, the two cylinders highlighted by light beam 530 (and which make up a third circular table 540) were not displayed in FIG. 1 because those cylinders were hidden within cube 155. In one embodiment, the invention visually identifies virtual objects that are hidden within other objects, that are underground, or that are located beyond the horizon.

Now that the first, second and third circular tables have been visually identified by the invention (since those tables consist of all of the cylinder prim types in the virtual world), the invention receives from the user her choice of which of these objects should be modified. In one embodiment, the user may manually indicate her selection by clicking on each object to be modified. In another embodiment, the user may use a dialog box (not shown) or other software command to indicate her preferences. In one embodiment, the user may indicate her choice by using a range, entering one or more criteria (such as object attributes), etc. For example, the user may indicate that of the six cylinder prims that are highlighted, she may wish to choose only those prims that are located within 3 meters of her avatar. The user may also indicate for those chosen objects, some object component should be modified. For example, she may wish that all of the highlighted cylinder prims within three meters of her avatar have the prim color changed to green. In such an example, the invention would then modify the prim color for prims 135 and 140 that together make up the first circular table, since these are the only cylinder prims that are located within 3 meters. The prim color for prims making up the second circular table 160 and the third circular table 540 would not be modified since they are not within 3 meters of the avatar.

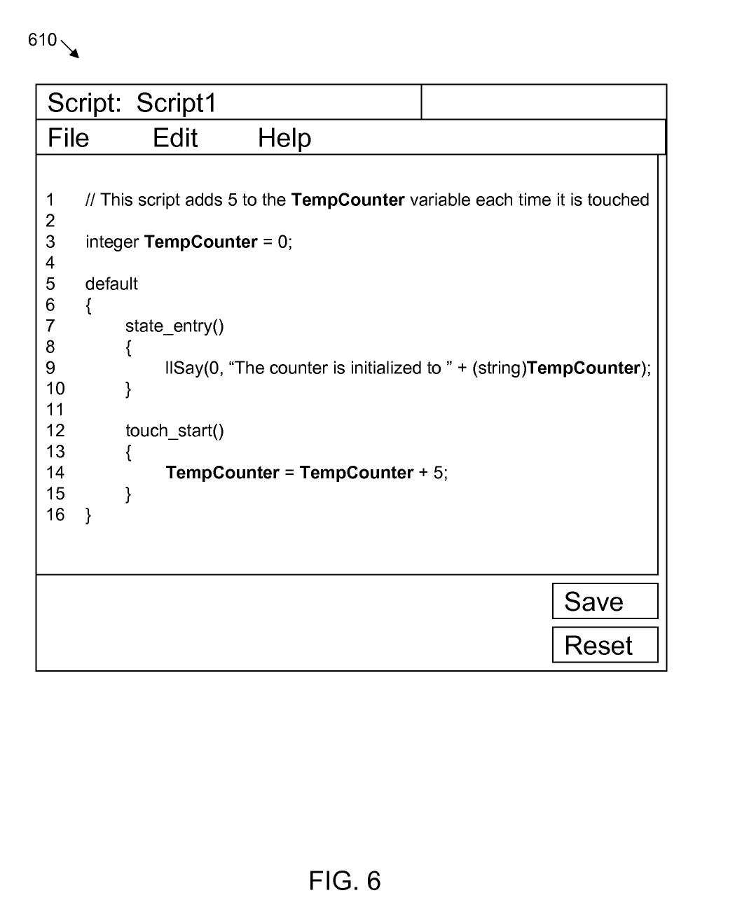

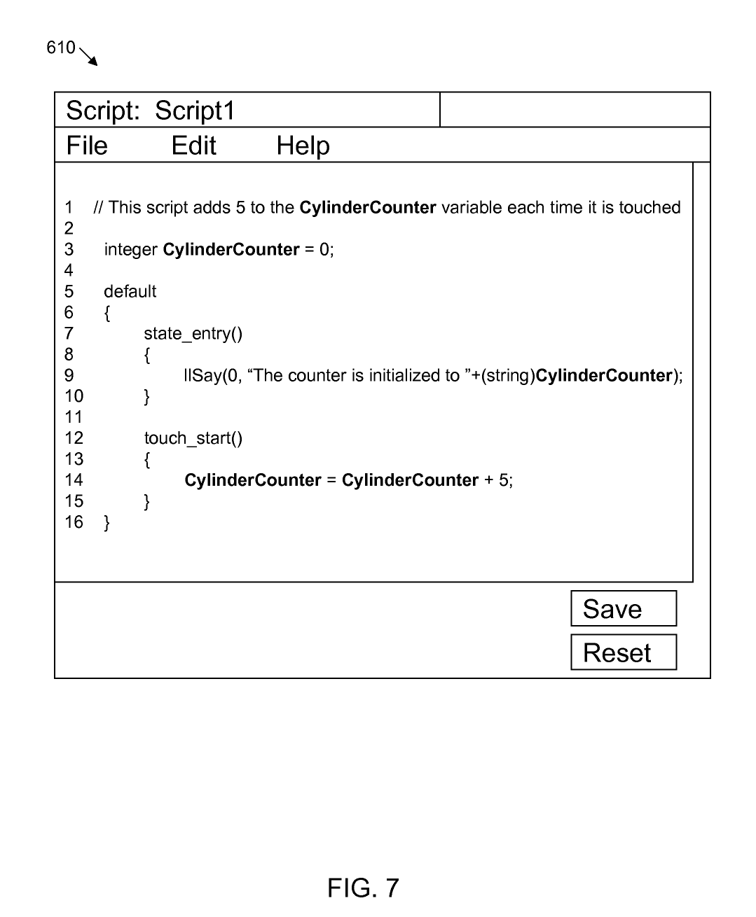

In one embodiment, at this time the light beams 510, 520, and 530 may be removed from the user's display. In other embodiment, the light beams may remain so that the user can choose other indicators from this grouping of circular tables for which object attributes, or object scripts should be modified. For example, once all of the cylinder prims within 3 meters have had their color changed, the user may desire to modify any script associated with the prims making up the three circular tables. In such an example, the user may indicate to the invention that any instance of the string “TempCounter” should be changed to “CylinderCounter”. FIG. 6 illustrates a script 610 associated with one of the prims that make up the second circular table 160. FIG. 7 illustrates the script 610 after the modification has been made by the invention. In this way, the invention allows a user to easily mass modify object components (such as object attributes or associated scripts) in a virtual world.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for managing object attributes in a virtual world environment, comprising:
selecting a plurality of selected objects by a supplied criterion;
visually identifying the plurality of objects to a user of the virtual world environment;
receiving from the user an indication of a plurality of chosen objects from the plurality of selected objects; and
modifying an object component for the plurality of chosen objects.

2. The method from claim 1, wherein the indication of a plurality of chosen objects is made by the user supplying a second criterion by which the plurality of chosen objects are selected.

3. The method from claim 1, wherein the object component is an object attribute of the chosen object.

4. The method from claim 1, wherein the object component is a script associated with the chosen object.

5. The method from claim 1, wherein the supplied criterion is a range.

6. The method from claim 1, wherein the objects from the plurality of selected objects differ in object type.

7. The method from claim 1, wherein visually identifying the plurality of objects comprises setting a lighting attribute.

8. A system for managing object attributes in a virtual world environment, comprising:
a selector module that selects a plurality of selected objects by a supplied criterion;
a identifier module that visually identifies the plurality of objects to a user of the virtual world environment;
a receiver that receives from the user an indication of a plurality of chosen objects from the plurality of selected objects; and
a modifier module that modifies an object component for the plurality of chosen objects.

9. The system from claim 8, further comprising a selection module that enables the user to supply a second criterion by which the plurality of chosen objects are selected.

10. The system from claim 8, wherein the object component is an object attribute of the chosen object.

11. The system from claim 8, wherein the object component is a script associated with the chosen object.

12. The system from claim 8, wherein the supplied criterion is a range.

13. The system from claim 8, wherein the objects from the plurality of selected objects differ in object type.

14. The system from claim 8, wherein the identifier module sets a lighting attribute for the plurality of objects.

15. A computer program product for managing object attributes in a virtual world environment, the computer program product comprising:
computer readable storage medium having computer readable program code embodied therewith, the computer readable program code comprising:
computer readable program code configured to select a plurality of selected objects by a supplied criterion;
computer readable program code configured to visually identify the plurality of objects to a user of the virtual world environment;
computer readable program code configured to receive from the user an indication of a plurality of chosen objects from the plurality of selected objects; and
computer readable program code configured to modify an object component for the plurality of chosen objects.

16. The computer program product from claim 15, wherein the indication of a plurality of chosen objects is made by the user supplying a second criterion by which the plurality of chosen objects are selected.

17. The computer program product from claim 15, wherein the object component is an object attribute of the chosen object.

18. The computer program product from claim 15, wherein the object component is a script associated with the chosen object.

19. The computer program product from claim 15, wherein the supplied criterion is a range.

20. The computer program product from claim 15, wherein visually identifying the plurality of objects comprises setting a lighting attribute.
